(19) United States
(12) Patent Application Publication
(10) Pub. No.: US 2024/0341227 A1
(43) Pub. Date: Oct. 17, 2024

(54) SYSTEMS AND METHODS FOR CROP RESIDUE MONITORING

(71) Applicant: DEERE & COMPANY, Moline, IL (US)

(72) Inventors: Nathan R. Vandike, Geneseo, IL (US); Martin Franz Unterpaintner, Saarbruecken (DE); Benjamin Peschel, Contwig (DE)

(21) Appl. No.: 18/298,485

(22) Filed: Apr. 11, 2023

(51) Int. Cl. A01D 41/12; A01D 41/127; G06T 5/50; G06T 7/50; G06T 7/62; G06T 17/00; G06V 10/44; G06V 20/10

(52) U.S. Cl. CPC A01D 41/1243; A01D 41/127; G06T 5/50; G06T 7/50; G06T 7/62; G06T 17/00; G06V 10/44; G06V 20/188; G06T 2207/20221

(57) ABSTRACT

One or more sensors can capture images of at least a portion of crop residue, which can be shown in real time on a display. Information captured by the sensors can be used to determine crop residue parameter information. The crop residue information can pertain to either or both the processing of crop residue by, or the distribution of crop residue from, the agricultural machine. Virtual representations of the crop residue parameter information can overlay at least a portion of, or otherwise be presented in connection with, the captured image shown on the display. The virtual representation can have an appearance that can visually convey the crop residue parameter information to an operator. Such visual representations can include the use of parameter identifiers, graphical shapes, or text, as well as combinations thereof. The virtual representation of the crop residue parameter information can also provide an indication as to whether the crop residue parameter information satisfies a predetermined threshold.

### BACKGROUND

Crop residue is often generated via an agricultural operation, such as, for example, a harvesting operation. Such crop residue can include, for example, straw, chaff or other unwanted portions of a crop plant, as well as other biomass such as weeds, weed seeds and the like. During a harvesting operation, crop residue can be chopped by an agricultural machine prior to being discharged from the agricultural machine and deposited onto an adjacent ground surface.

Generally, crop residue that is deposited, such as spread, across at least a portion of a ground surface by the agricultural machine at least partially degrades over time. However, various factors can play a role in the extent or speed at which the deposited crop residue does, or does not, degrade. Such factors can include, for example, characteristics relating to the depths of collections of crop residue that are spread onto the ground surface, as well as physical characteristics of the crop residue. For example, the rate at which crop residue in a collection of crop residue degrades can be impacted by the vertical depth of that collection of crop residue. Thus, uneven distribution in at least terms of the vertical depths of the collections of crop residue that are spread across the ground surface of a field can result in uneven degradation of crop residue across the field. The rate at which crop residue degrades can also be impacted by physical characteristics of the crop residue, such as, for example, a chopped length of the crop residue.

Uneven rates of degradation of crop residue across a field can at least contribute to variances in the soil temperature and moisture content of the field. Such variances can be detrimental to seed emergence, and can thus adversely impact the associated crop yield. However, preventing such issues is often problematic. For example, crop residue is typically deposited from a rearward location of the agricultural machine, and thus generally occurs outside the line of sight of the operator of the agricultural machine. Further, operator view of crop residue deposited from the agricultural machine can be obscured by environmental factors, including dust. Additionally, traditionally, automated crop residue distribution systems do not provide feedback regarding actual or real time performance of such distribution systems, which can adversely impact operator confidence in the performance of those automated systems.

### BRIEF SUMMARY

An aspect of an embodiment of the present disclosure is a method that includes displaying one or more first images of at least a crop residue on a display, and identifying captured information in at least a portion of the one or more first images. Additionally, one or more representations of the crop residue in the captured information can be identified, and crop residue parameter information can be determined using at least one of the identified one or more representations of the crop residue. Further, a virtual representation of the determined crop residue parameter information can be displayed with the display of the one or more first images.

Another aspect of an embodiment of the present disclosure is a system for displaying a virtual representation of a crop residue parameter information for a crop residue. The system can include at least one display, at least one processor, and a memory coupled with the at least one processor. The memory can include instructions that when executed by the at least one processor cause the at least one processor to display one or more first images of at least the crop residue on the display. The processor can further be configured to identify captured information in at least a portion of the one or more first images, and identify one or more representations of the crop residue in the captured information. Additionally, the processor can further be configured to determine the crop residue parameter information from at least one of the one or more representations of the crop residue, and display the virtual representation of the determined crop residue parameter information with the display of the one or more first images.

These and other aspects of the present disclosure will be better understood in view of the drawings and following detailed description.

### BRIEF DESCRIPTION OF THE DRAWINGS

FIG. 1 illustrates a partial cutaway side view of an exemplary agricultural machine.

FIG. 2 illustrates an enlarged view of an exemplary optical device in the form of a camera that is mounted to a portion of the agricultural machine shown in FIG. 1.

FIG. 3 illustrates a block diagram of an exemplary crop residue monitoring system.

FIG. 4 illustrates portions of a crop residue monitoring system that can monitor parameters of crop residue either, or both, being processed by or discharged from an agricultural machine.

FIG. 5 illustrates a simplified flow diagram of an exemplary method for operating the illustrated crop residue monitoring system.

FIG. 6A illustrates a display showing, as being captured by a sensor of the agricultural machine, an exemplary image of crop residue spread on a ground surface of a field.

FIG. 6B illustrates an exemplary overlay providing crop residue parameter information that is positioned over at least a portion of the image that is being displayed in FIG. 6A.

FIG. 7A illustrates a display showing, as captured by a sensor of the agricultural machine, an exemplary image of a collection of crop residue spread on a ground surface of a field.

FIG. 7B illustrates an exemplary overlay providing sensed crop residue parameter information that is positioned over at least a portion of the image that is being displayed in FIG. 7A.

FIG. 8A illustrates a display showing, as being captured by a sensor of the agricultural machine, an exemplary image of chopped crop residue that is located within an interior portion of an agricultural machine.

FIG. 8B illustrates an exemplary overlay providing sensed crop residue parameter information that is positioned over at least a portion of the image that is being displayed in FIG. 8A.

FIGS. 8C and 8D illustrate exemplary overlays providing sensed crop residue parameter information being shown on the display with the image of the chopped crop residue that is being displayed in FIG. 8A.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

Disclosed are examples of crop residue monitoring systems, methods and machine-readable mediums that monitor crop residue parameters, including, for example, parameters relating to either, or both, chopped sizes of crop residue and crop residue spreading. Embodiments disclosed herein also relate to overlaying such parameter related information on one or more actual images of crop residue, including live images, on one or more displays of the agricultural machine. Such overlaid information can be presented in a manner that can assist an operator of the agricultural machine with determining what, if any, changes are to be made in the operation of the agricultural machine. Additionally, or alternatively, the disclosed systems, methods and mediums can further use the monitored crop residue information to automatically implement changes in the operation of the agricultural machine.

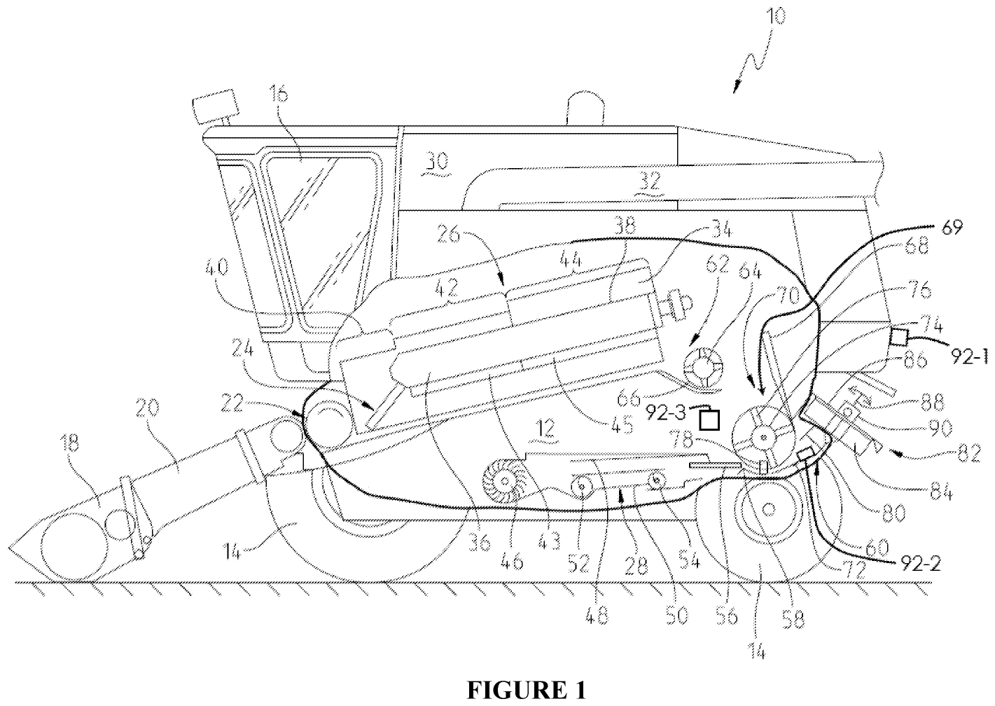

In FIG. 1, an embodiment of an agricultural machine 10 is shown. The agricultural machine 10 includes a frame 12 and one or more ground engaging mechanisms, such as wheels 14 or tracks, that are in contact with an underlying ground surface. In the illustrative embodiment, the wheels 14 are coupled to the frame 12 and are used in connection with propulsion of the agricultural machine 10 in at least a forward operating direction (which is to the left in FIG. 1), as well as in other directions. In some embodiments, operation of the agricultural machine 10 is controlled from an operator cab 16. The operator cab 16 can include any number of controls for controlling the operation of the agricultural machine 10, such as a user interface, among others. In some embodiments, operation of the agricultural machine 10 can be conducted by a human operator in the operator cab 16, a remote human operator, or an automated system, as well as combinations thereof.

A cutting head 18 can be disposed at a forward end of the agricultural machine 10 and is used to harvest crop, as well as to conduct the harvested crop to a slope conveyor 20. The slope conveyor 20 conducts the harvested crop to a guide drum 22. The guide drum 22 guides the harvested crop to an inlet 24 of a threshing assembly 26, as shown in FIG. 1. The threshing assembly 26 includes a housing 34 and one or more threshing rotors 36. A single threshing rotor 36 is shown in FIG. 1 that includes a drum 38. The illustrated threshing assembly 26 includes a charging section 40, a threshing section 42, and a separating section 44. The charging section 40 is arranged at a front end of the threshing assembly 26, the separating section 44 is arranged at a rear end of the threshing assembly 26, and the threshing section 42 is arranged between the charging section 40 and the separating section 44.

Harvest crop that includes grain, such as corn, and material other than grain (MOG) can fall through a thresher basket 43 positioned in the threshing section 42 and through a separating grate 45 positioned in the separating section 44. The harvested crop can be directed to a clean crop routing assembly 28 with a blower 46 and sieves 48, 50 with louvers. The sieves 48, 50 can be oscillated in a fore-and-aft direction. The clean crop routing assembly 28 can remove the MOG and guides grain over a screw conveyor 52 to an elevator for grain. The elevator for grain deposits the grain in a grain tank 30, as shown in FIG. 1. The grain in the grain tank 30 can be unloaded by means of an unloading screw conveyor 32 to a grain wagon, trailer, or truck, for example.

Harvested crop remaining at a rear end of the sieve 50 is again transported to the threshing assembly 26 by a screw conveyor 54 where it is reprocessed by the threshing assembly 26. Harvested crop delivered at a rear end of the sieve 48 is conveyed by an oscillating sheet conveyor 56 to a lower inlet 58 of a crop debris routing assembly 60. Harvested crop at the threshing assembly 26 is processed by the separating section 44 resulting in straw being separated from other material of the harvested crop. The straw, among other crop residue, is ejected through an outlet 62 of the threshing assembly 26 and conducted to an ejection drum 64. The ejection drum 64 interacts with a sheet 66 arranged underneath the ejection drum 64 to move the straw, among other crop residue, rearwardly. A wall 68 is located to the rear of the ejection drum 64 and guides the straw into an upper inlet 70 of the crop debris routing assembly 60.

The crop debris routing assembly 60 includes a chopper 69 that is coupled to an actuator that can provide a force to drive rotational displacement of at least a chopper rotor 74. Moreover, the chopper 69 can have a chopper housing 72, the chopper rotor 74 being arranged in the chopper housing 72. According to certain embodiments, the chopper rotor 74 can rotate, for example, via operation of the actuator, in a counter-clockwise direction about an axis that can extend perpendicular to the forward operating direction. The chopper rotor 74 includes a plurality of chopper knives 76 that are distributed around a circumference of the chopper rotor 74. The chopper knives 76 interact with opposing knives 78, which are, for example, coupled to the chopper housing 72. The chopper knives 76 and the opposing knives 78 cooperate to chop crop residue, including straw, into smaller pieces.

One or more spreaders 82 are provided downstream of an outlet 80 of the crop debris routing assembly 60. One spreader 82 is shown in FIG. 1. The spreader 82 may include a number of impeller blades 84, each of which is connected to a disk 86 that rotates about a central axis 88. The impeller blades 84 extend downwardly from the disk 86 and, for example, radially outwardly from the central axis 88. The disk 86 and the impeller blades 84 coupled thereto are rotatably driven by a hydraulic motor 90. Chopped crop residue, including, for example, straw is moved through the outlet 80 of the crop debris routing assembly 60 to the spreader 82. Rotation of the impeller blades 84 of the spreader 82 spreads the chopped crop residue as it exits the agricultural machine 10.

One or more sensors 92 can be positioned at a variety of locations along the agricultural machine 10. The sensors 92 can be utilized by, or be part of, one or more systems of an agricultural machine 10. Further, information or data provided by, or derived from, the sensor 92 (referred to herein as captured information) can be utilized to generate information that can be used by a controller of the agricultural machine 10, or other controllers that may be either, or both, separate or remote from the agricultural machine 10, which can generally be referred to as off-board controllers. For example, such off-board controllers can be part of a computing device that is not directly part of the agricultural machine 10, including, but not limited to, a mobile phone, smartphone, tablet, and personal computer, among other off-board computing devices.

The captured information can be derived from a variety of different types of information, or data provided by the sensors 92, including, for example, from information provided by the sensors 92 in one or more images, videos, waveforms, or signals, or combinations thereof, that may be detected captured, received, or recorded by the sensors 92. Such captured information can be used by the controller in connection with parameters relating to the crop residue, including, but not limited to, parameters related to a size of chopped crop residue and parameters relating to the spreading of crop residue on the ground surface, as well as combinations thereof, among other crop residue parameters. Additionally, as discussed below, representations of such parameters, among other information, can be visually displayed or depicted to an operator of the agricultural machine 10, such as, for example, via one or more overlays that are displayed on generally live or real time images on a display of the agricultural machine 10. Additionally, or alternatively, such representations of such parameters, among other information, can be visually displayed or depicted on a display of an off-board computing device. Further, as discussed below, such representations of information regarding the determined parameters can be utilized by the operator in connection with deciding whether to adjust an operation of the agricultural machine 10. Additionally, or alternatively, information regarding the crop residue parameters can be utilized by the controller in connection with the controller at least facilitating automatic adjustment of one or more operations of the agricultural machine 10.

A variety of different types of devices, as well as combinations of different types of devices, can be utilized for the sensor 92. For example, the sensor 92 can include, but is not limited to, one or more visible light cameras, near-visible light cameras, depth cameras, depth sensors, infrared cameras, optical cameras, thermal imaging cameras, ultrasonic sensors, radar, radar-based cameras, hyperspectral cameras, and light imaging detection and radiation (LIDAR) sensors, among other types of sensors.

The sensors 92 can be located at a variety of positions about the agricultural machine 10, including within, or along exterior portions, of the agricultural machine 10, as well as combinations thereof. With respect to the illustrated exemplary embodiment in which the agricultural machine 10 is a harvester, one or more sensors 92-1, 92-2, 92-3 (generally referred to herein as sensor 92) can be positioned at locations downstream of the threshing assembly 26, at the threshing assembly 26, and upstream of the threshing assembly 26, among other locations. Additionally, or alternatively, with such harvester embodiments, a sensor 92 can be positioned to capture images of crop residue prior to discharge of the crop residue from the agricultural machine 10. Further, multiple sensors 92, which may, or may not, be positioned at similar positions along the agricultural machine 10, can be utilized to capture images at one or more locations or stages along the agricultural machine 10.

FIG. 1 provides a non-limiting example of a plurality of sensors 92 positioned at locations both within and outside of the agricultural machine 10 to capture information relating to crop residue at various stages or times, including both prior to and following discharge of the crop residue from agricultural machine 10. At least some of the sensors 92 can be secured, or otherwise coupled to, the agricultural machine 10, including, for example, to the frame 12 of the agricultural machine 10. For example one or more first sensors 92-1 can capture images of crop residue that has been discharged from the agricultural machine 10, including either, or both, as the discharged crop residue is in the air and above the ground surface or is spread onto the ground surface outside of the agricultural machine 10 by the spreader 82. Moreover, the first sensor 92-1 can provide captured information that can be used to determine one or more crop residue parameters relating to either or both the discharge or spreading of crop residue. For example, such crop residue parameters can include, for example, the area(s), portions, or percentages of the ground surface being, or not being, covered by discharged crop residue (also referred to as the coverage area and non-coverage area), the location of crop residue that has been spread onto a ground surface, the width(s) of the spread crop residue, or an associated depth of a collection(s) of the crop residue that has been spread onto the ground surface, as well as combinations thereof. Additionally, such crop residue parameters can relate to properties or characteristics of crop residue that is airborne after being discharged from the agricultural machine, and prior to reaching, or being deposited onto, the ground surface. Such characteristics of the airborne crop residue can include, for example, either or both a width of one or more collections of crop residue that are airborne or a density of the collection of airborne crop residue. For example, at least one first sensor 92-1 can be an optical camera that can provide captured information used to detect the presence, or absence, of airborne crop residue. According to other embodiments, the first sensor 92-1 can be presence or absence sensor that can be used to detect the presence, or absence, of areas of light amongst a collection of airborne crop residue. Detection of the presence, or absence, of crop residue or light, or both, among other captured information, can be used with other size information, such as, as for example, a size of a corresponding area occupied by the airborne crop residue, to derive an indication of a density of crop residue that is, or is not, being deposited onto one or more areas of the ground surface.

According to certain embodiments, the first sensor 92-1 can comprise one or more optical camera or a depth cameras or sensors, including, but not limited to, stereo depth cameras, stereo sensors, time of flight sensors, RGBD (red, green, blue, depth) cameras, three-dimensional sensors, three-dimensional cameras, structural light sensors, or light detection ranging sensors, as well as combinations thereof, among others. Additionally, or alternatively, the first sensor 92-1 can comprise at least one sensor 92-1, such as, for example, an optical camera, that can obtain a visual or optical image of the crop residue, and at least one other, different type of sensor 92-1, such as, for example, LIDAR, among others, that can obtain information regarding a distance(s), relative depth(s), or other measurement(s) for the object(s) that is/are being captured in the image by the other first sensor 92-1 (e.g., the optical camera). According to such embodiments, the captured information obtained by the different types of sensors of the one or more first sensors 92-1 can be correlated so that a variety of different types of information can be determined.

According to certain embodiments, the first sensor 92-1 can be supported by the frame 12 or other portion of the agricultural machine 10 so that the first sensor 92-1 is focused, at least partially, on a region behind the agricultural machine 10. Additionally, or alternatively, one or more sensors 92-1 can be mounted to mirror arms or sides of the agricultural machine 10, among other locations. As discussed below, captured information from the first sensor 92-1 can be utilized to evaluate one or more parameters that can indicate whether discharged crop residue is, or is not, being generally evenly spread or distributed along the ground surface.

Additionally, one or more second sensors 92-2 can be positioned to capture images of crop residue after the crop residue has been chopped by the chopper 69, and prior to the crop residue being discharged and spread by the spreader 82. As discussed below, the one or more sensors 92-2 can be positioned such that the parameters provided by, or determined from analyzing, the captured information obtained by the second sensor 92-2 can correspond to a size or shape, or both, of the crop residue that has been chopped by the chopper 69. For example, the captured information provided by the second sensors 92-2 can provide, or be used to determine, residue parameter information regarding an extent to which the crop residue has been processed. Such crop residue parameter information can include, for example, either or both a visual or a measured representation of a length(s) of the crop residue that has been processed, such as, for example, chopped by the chopper 69. For example, according to certain embodiments, the crop residue parameter information can correspond to whether the crop residue can be grouped into one or more processing categories. As discussed below, such processing categories can convey whether, based on an appearance or size of the crop residue, the crop residue has, or has not, been processed to attain certain selected characteristics. Further, such crop residue parameter information(s) can provide information regarding characteristics of the crop residue that is being discharged from, and spread onto the field onto, the agricultural machine 10.

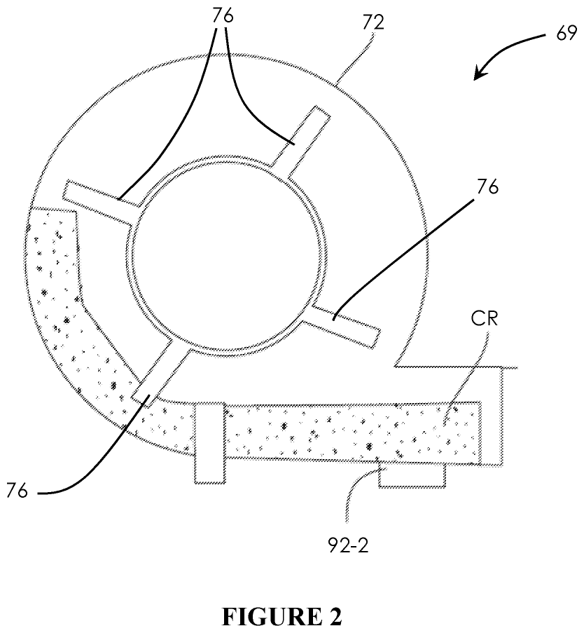

FIG. 2 is an enlarged view of the exemplary second sensor 92-2 that is in the form of an optical camera. The illustrated second sensor 92-2 can be supported between the chopper 69 and the spreader 82. According to certain embodiments, the second sensor 92-2 can include a protective cover or transmission surface that is positioned to protect the second sensor 92-2 from damage related to direct exposure of the second sensor 92-2 to crop residue (as generally indicated by “CR” in FIG. 2). Thus, for example, according to certain embodiments, the protective cover can be a transparent protective panel.

In addition to, or in lieu of, the above-discussed first and second sensors 92-1, 92-2, other sensors 92 can be positioned in a variety of other locations about the agricultural machine 10 to provide information regarding one or more parameters of the crop residue. For example, one or more third sensors 92-3 can be positioned to capture information regarding crop residue that is moving between the outlet 62 of the threshing assembly 26 and the chopper 69, and which is positioned upstream of the spreader 82. Additionally, or alternatively, one or more of third sensors 92-3 can be positioned to capture images of crop residue being blown from a chaffer/sieve 48 towards the chopper 69. Captured information provided by such third sensors 92-3 can indicate, or be used to determine, for example, the size of the crop residue that is to be chopped by the chopper 69. Moreover, such information from the third sensor 92-3 can indicate the extent the chopper 69 is to be operated to process, including chop, crop residue such that the crop residue, or a certain percentage of the crop residue, has a visual or measured size or other characteristic, such as, for example, a visual or measured length, that is within a preselected threshold, including within a range of such a preselected threshold. According to certain embodiments, the information provided by at least the third sensor 92-3 can also be utilized to determine and convey information regarding the extent crop material has, or has not, been processed to attain one or more select characteristics, including, but not limited to, size characteristics. For example, as discussed below, such determined characteristics can provide an indication as to whether crop residue has been over processed, under processed, or processed to attain the selected characteristic(s).

Sensors 92 can also be positioned in a variety of other locations. For example, one or more sensors 92 can be positioned to capture information regarding crop that is being collected by the agricultural machine 10, while one or more other sensors can be positioned to capture information that may be utilized in connection with the position or location of approaching crop and associated crop rows, among other information. Thus, the foregoing are merely examples of locations for sensors 92, and certain agricultural machines 10 can have one or more sensors 92 positioned at a variety of other locations, including at locations either within, or outside of, the agricultural machine 10, as well as combinations thereof.

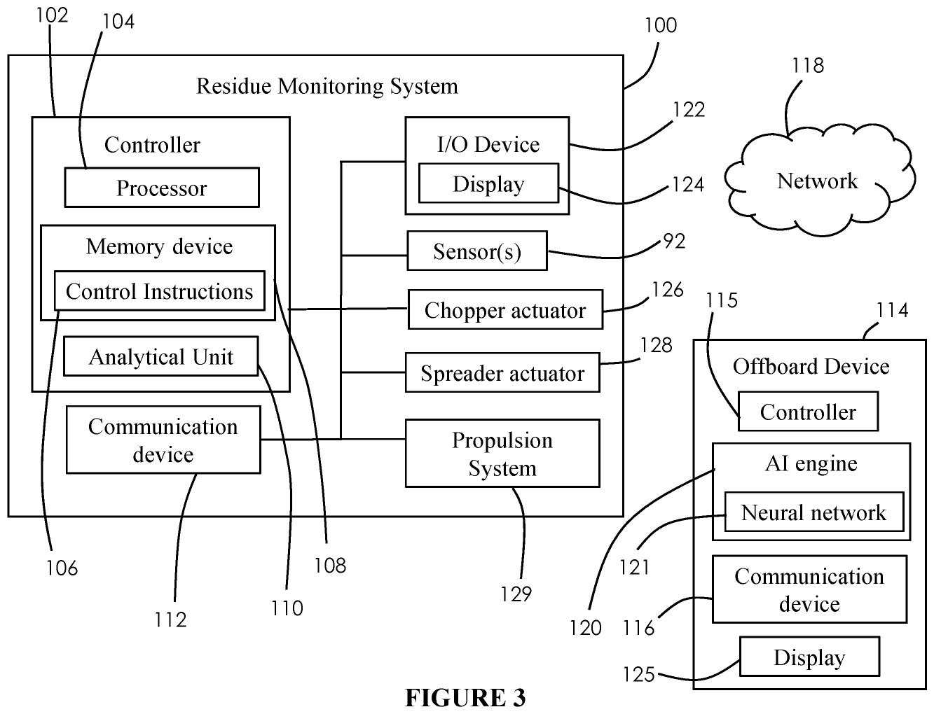

FIG. 3 is a block diagram of an exemplary crop residue monitoring system 100. The system 100 can include a controller 102 having one or more processors 104 that can follow instructions, including control instructions 106, contained on one or more memory devices 108, including, for example, a non-transitory machine-readable medium. While the below-discussed control instructions 106 are illustrated as being part of the memory device 108, according to certain embodiments, the control instructions 106 can be separate from the memory device 108. Further, the controller 102 can be part of the agricultural machine 10, and can adjust the operational settings of the agricultural machine 10 at a variety of different times, including real-time adjustments while the agricultural machine 10 is operating in a field. Examples of such operational settings include, but are not limited to, a speed of travel of the agricultural machine 10, chopper 69 speed, harvester feed rate, chopper knife 78 position, header height, spreader 82 speeds, spreader vane positions, threshing speed, cleaning speed, threshing clearance, and sieve louver positions, among other operations or settings.

The controller 102 can also include an analytical unit 110 that can include a processing unit that follows instructions contained on a non-transitory computer-readable or machine-readable medium, including, for example, stored in the memory device 108. The analytical unit 110 can receive captured information obtained by, or derived from, the sensors 92. Based on an analysis of the captured information, such as, for example, an optical analysis, the analytical unit 110 can derive one or more parameters from the crop residue, also referred to as crop residue parameter information. According to certain embodiments, the crop residue parameter information can correspond to a physical characteristic of the crop residue, the distribution or spreading of crop residue from the agricultural machine 10 while the crop residue is airborne, the coverage area(s) on the ground surface at which crop residue is spread, the non-coverage area(s) on the ground surface onto which little or no discharged crop residue is deposited or spread, or a collection of crop residue, as well as combinations thereof.

The system 100 can further include a communications device 112 that can communicate information from, as well as receive information to, the system 100 and other agricultural machines, devices, and databases 114 (collectively referred to herein as off-board device 114). The communications device 112 can be embodied as hardware, firmware, software, virtualized hardware, emulated architecture, and/or a combination thereof. According to certain embodiments, the communications device 112 can comprise a transceiver that is configured to wirelessly communicate information, as well as receive information, that may pertain to, or assist, the system 100, in determining crop residue parameter information.

The communication device 112 can, according to certain embodiments, exchange communications with a communication device 116 of one or more off-board devices 114, such as, for example, via a network 118, including, for example, via internet, cellular, and/or Wi-Fi networks. The off-board device(s) 114 can utilize the captured information received from the agricultural machine 10, as well as from other agricultural machines and equipment, in connection with training a neural network 121 of an artificial intelligence (AI) engine 120. Further, the off-board device(s) 114 can include a controller 115 and display 125 similar to the controller 102 and display 124 discussed herein with respect to the residue monitoring system 100. While the AI engine 120 and associated neural network 121 are illustrated in FIG. 3 as being part of the off-board device 114, according to certain embodiments, in addition to, or in lieu of, being included with the off-board device 114, the AI engine 120 and associated neural network 121 can be included with the agricultural machine 10, including be part of the residue monitoring system 100.

According to certain embodiments in which one or more of the sensor 92 is/are an optical camera, the analytical unit 110 can evaluate captured information pertaining to the crop residue on a pixel level or based on a collection or area(s) of pixels, among other basis for evaluation. Such an evaluation can be based, for example, at least in part on either or both a color and level of light present, or not present, in an area(s) or pixels in the captured information. Further, such evaluation can, according to certain embodiments, be based on information stored or programmed in the system 100 that was derived by the AI engine 120, including, for example, models or algorithms developed by the training of the neural network 121 of the AI engine 120. According to certain embodiments, the information derived by the AI engine 120 can be part of one or more of the control instructions 106, memory device 108, or analytical unit 110, among other portions of the system 100. Further, according to certain embodiments, once the information derived by the AI engine 120 is programmed or otherwise stored as part of the residue monitoring system 100, subsequently derived information, updates to information, algorithms, or models by the AI engine 120, including developed in association with machine learning by the neural network 121, may, or may not, be communicated to the system 100, such as, for example, via a software update.

Crop residue parameter information derived by the controller 102, including, for example, via the analytical unit 110, can be utilized to generate a visual representation of the derived information that can be overlaid on actual images being displayed on the display 124 that are being provided by one or more of the sensors 92. Thus, for example, derived crop residue parameter information, as derived by either or both the analytical unit 110 and the processor 104, can be used by the processor 104 to generate a virtual or graphical representation of the derived crop residue parameter information that can be shown on one or more input/output (I/O) devices 122 of the system 100. For example, the virtual or graphical representation of the derived crop residue parameter information can be shown on one or more displays 124 of the I/O device 122, including, for example, a monitor, screen, or touch screen, as well as any combination thereof, among other types of displays. According to certain embodiments, the display 124 can be positioned in the operator cab 16 of the agricultural machine 10. Additionally, or alternatively, the display 125 of the off-board device 114 can be utilized to display information that is at least similar to that displayed on the display 124 in the operator cab 16. Further, as previously discussed, such an off-board device 114 can be part of a mobile or handheld device or other device that can be located remote to the agricultural machine 10, thereby allowing the system 100 to be distributed across multiple devices, controllers, displays, and locations. The I/O device 122 can also include a variety of other types of user interfaces, including, but not limited to, a keypad, keyboard, mouse, touchscreen, or joint stick, as well as combinations thereof, among other devices.

According to certain embodiments, the analytical unit 110 can also be configured to determine, based on the derived crop residue parameter information, adjustments that can be, or alternatively are to be, made to attain certain thresholds with respect to the crop residue parameter(s). Using the derived crop residue parameter information, the analytical unit 110 can determine adjustments that, if implemented, could adjust operations of the agricultural machine 10 that can facilitate a change in a crop residue parameter. For example, according to certain embodiments, information derived by the analytical unit 110 can be used to facilitate a change in the speed at which a chopper actuator 126 provides a force to drive rotational displacement of at least the chopper rotor 74, and thus corresponding displacement of the chopper knives 76. Such changes in the speed at which at least the chopper rotor 74 operates can facilitate a change in a crop residue parameter, such as, for example, a length to which the crop residue is chopped by operation of the chopper 69. Additionally, or alternatively, information derived by the analytical unit 110 can be used to adjust, via operation of the chopper actuator 126 or another actuator associated with the chopper, a position of the knives 78 that oppose the chopper knives of the chopper 69.

Additionally, information derived by the analytical unit 110 can be used to facilitate operational changes that can impact the distribution of crop residue being discharged, or spread, from the agricultural machine 10 and onto the ground surface. For example, such adjustments can include adjusting the operation of a spreader actuator 128 so as to adjust either or both a speed of the spreader 82 or a position of spreader vanes of the spreader 82. Additionally, such operational changes can include adjusting a speed at which a propulsion system 129 of the agricultural machine 10 may be controlling the speed of travel of the agricultural machine 10.

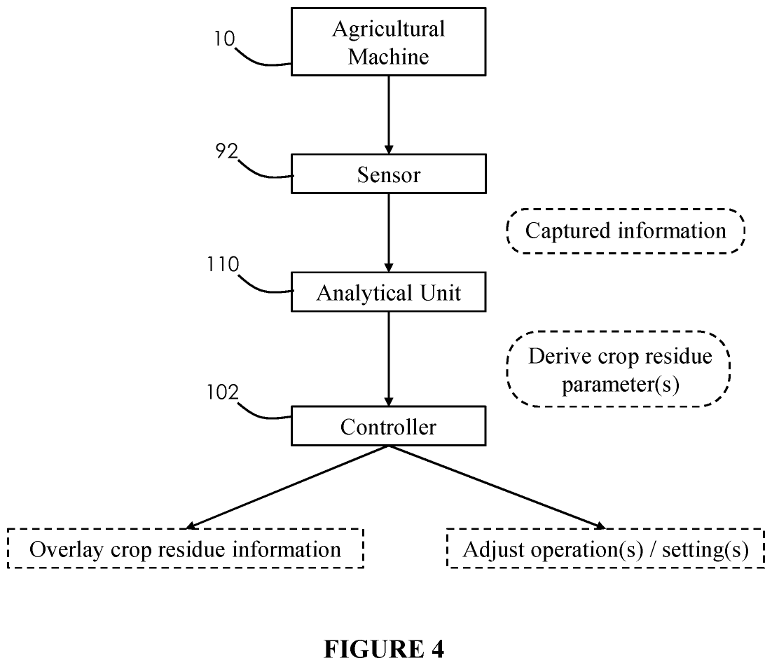

FIG. 4 illustrates portions of a crop residue monitoring system 100 that can monitor parameters of crop residue being either or both processed by and discharged from an agricultural machine 10. As indicated above, one or more sensors 92 of the agricultural machine 10 can capture, detect, or be used for providing, images, including, but not limited to one or more photographs or video, among other information that can be displayed on the display 124. The captured information obtained by the one or more sensors 92, including from an image captured by the sensors 92, can be analyzed by an analytical unit 110 to determine crop residue parameter information. For example, as discussed above, according to certain embodiments, such crop residue parameter information can relate to an indication of the extent crop residue has been processed, including, for example, chopped by the chopper 69. Thus, such crop residue parameter information can correspond to either, or both, a visual or measured representation of a length of crop residue, among other size or shape characteristics of the crop residue. As also previously mentioned, such crop residue information can relate to an evenness, or lack thereof, in a distribution of crop residue that is spread on the ground surface by the agricultural machine 10. Moreover, such a crop residue parameter can correspond to a determination or comparison of coverage areas (e.g. ground surface areas in which crop residue has been spread) and non-coverage areas (e.g., ground surface areas in which little or no crop residue has been spread). Also, such crop residue parameters can correspond to an amount or size of crop residue spread by the agricultural machine 10, including a width of a windrow, the amount of crop residue in collections of crop residue on the ground surface, and characteristics regarding crop residue that is airborne after having been discharged from the agricultural machine 10 and before reaching the ground surface.

According to certain embodiments, the controller 102, including one or more processors of the controller 102, can be used to generate visual representations, including, for example, virtual or graphical representations, of the crop residue parameter information for displaying on the display 124. As discussed above, such representations of the crop residue parameter information can be in the form one or more overlays that is/are overlaid over, or with, generally live, real time, or near real time images captured by one or more sensors 92 that are also being shown in the display 124. Additionally, or alternatively, a single display 124, or a plurality of displays 124, can be arranged such that an image(s) captured by the sensors 92 can be shown in a side-by-side arrangement with another showing of the image(s) captured by the sensors 92 that also includes an overlay of the crop residue parameter information. Thus, for example, a portion of single display 124, or at least one first display 124, can be arranged to show an image(s) captured by the one or more sensors 92 without the additional overlay having crop residue information, while another portion of the same display 124, or at least one second display 124, can show the same image(s) captured by the one or more sensors 92 with the additional overlay having crop residue information.

Alternatively, rather than being an overlay, the image(s) captured by the sensors 92 can be shown on a portion of a display 124 that is different than the portion of the display that shows the crop residue parameter information. In such an embodiments, the crop reside parameter information may not overlay the shown images that are captured from the sensor 92. According to another embodiment, the image(s) captured by the sensors 92 can be shown on a display 124 that is different than the display 124 that shows the crop reside parameter information. Again, with such an embodiment, the crop residue parameter information may not be presented as an overlay, and, more specifically, not shown over the image(s) captured by the sensors 92.

As also discussed above, such derived crop residue parameter information can be used in connection with determining adjusted operational settings that can for the agricultural machine 10, including, for example, with respect to the operation of one or more of the chopper actuator 126, spreader actuator 128, or propulsion system 129 of the agricultural machine 10, among other components of the agricultural machine 10. Such determined adjusted operational settings can be presented to the operator for determination as to whether such adjustments are to be implemented, or, according to other embodiments, be automatically implemented, such as, for example, by one or more signals generated by the controller 102.

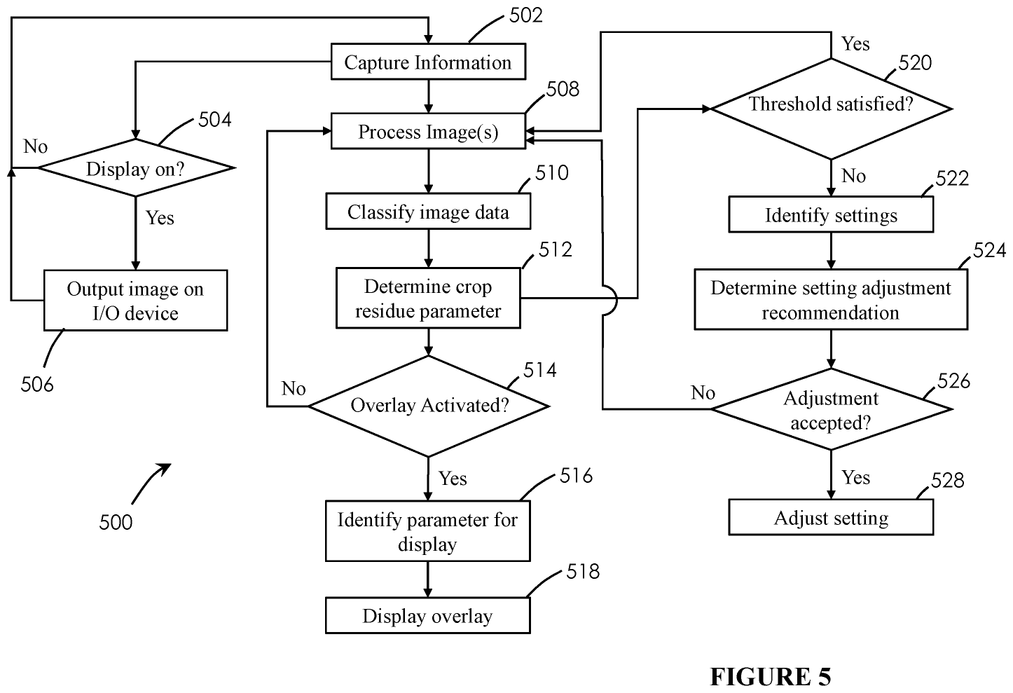

FIG. 5 illustrates a simplified flow diagram of an exemplary method 500 for operating the illustrated crop residue monitoring system 100. The method 500 is described below in the context of being carried out by the illustrated exemplary residue monitoring system 100. However, it should be appreciated that method 500 may likewise be carried out by any of the other described implementations, as well as variations thereof. Further, the method 500 corresponds to, or is otherwise associated with, performance of the blocks described below in the illustrative sequence of FIG. 5. It should be appreciated, however, that the method 500 can be performed in one or more sequences different from the illustrative sequence. Additionally, one or more of the blocks mentioned below may not be performed, and the method can include blocks other than those discussed below.

At block 502, one or more of the sensors 92 can capture information regarding the crop residue. For example, as discussed above, one or more of the first sensor 92-1 can capture images of crop residue that has been discharged from the agricultural machine 10, including either or both while the discharged crop residue is airborne or has been spread onto the ground surface. Additionally, other sensors 92-2, 92-3 can capture images of crop residue being processed or conveyed by the agricultural machine 10. According to certain embodiments the sensors 92-1, 92-2, 92-3 can be optical cameras that can capture video or photographs. With respect to embodiments in which the sensors 92-1, 92-2, 92-3 are capturing photographs, the sensors 92-1, 92-2, 92-3 can capture photographs at predetermined time intervals. The duration of the time intervals can be based on variety of criteria, including, for example, based on the speed at which the analytical unit 110 is anticipated to analyze or process the captured information from the image(s) captured by the sensor(s) 92-1, 92-2, 92-3. The time intervals can also be based on the speed at which the agricultural machine 10 is moving along the ground surface, or the speed at which the agricultural machine 10 is harvesting, processing, or conveying crop or crop residue, among other factors.

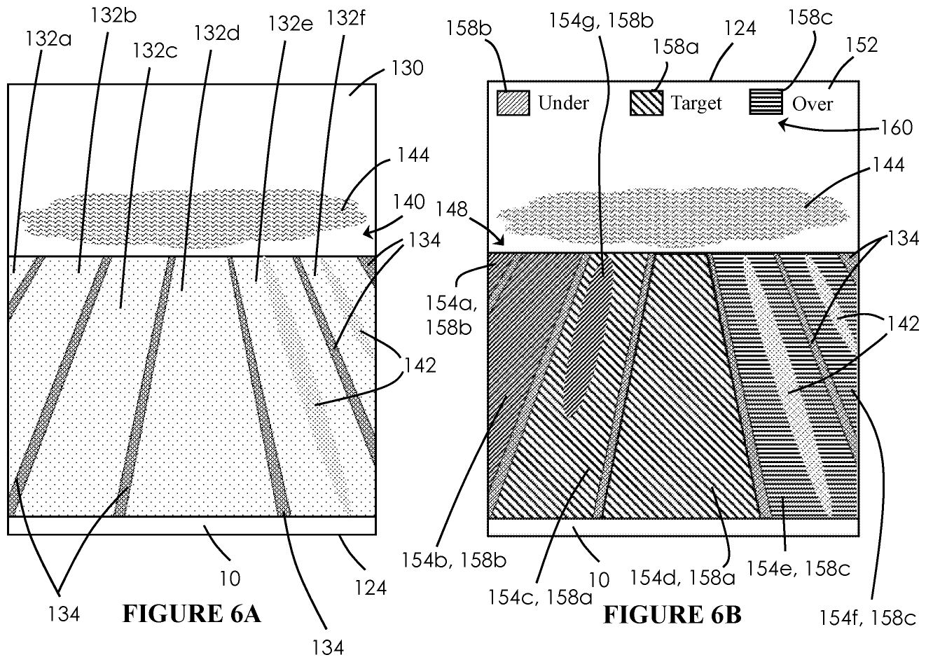

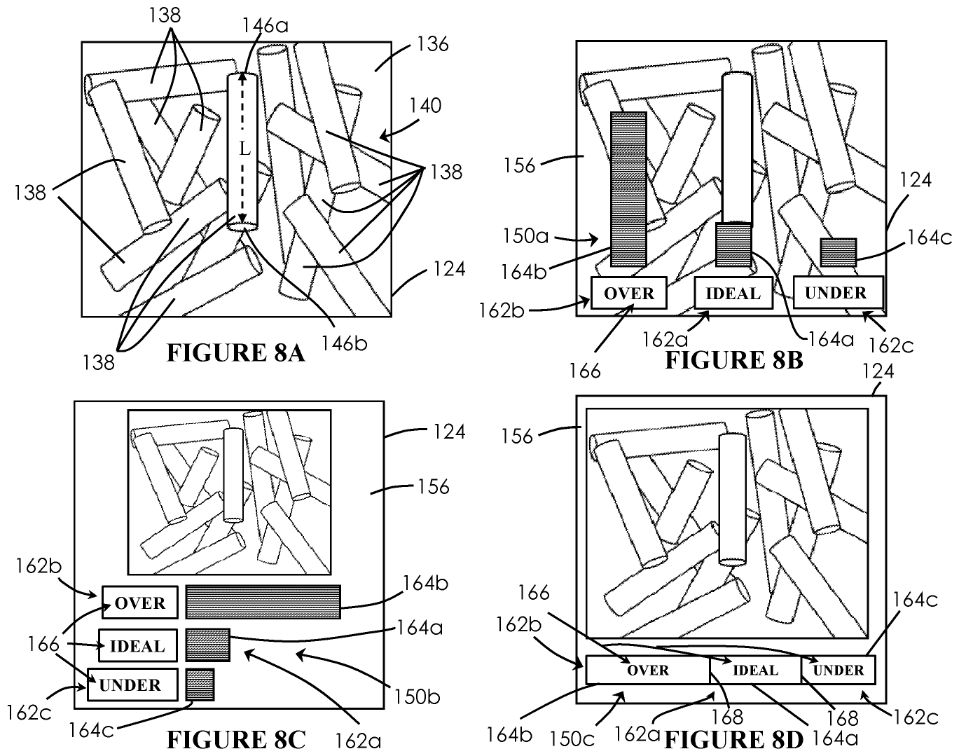

If the display 124 is active, such as, for example, powered on and currently in an operational state or condition, as determined at block 504, the image(s) captured by the sensor(s) 92 can be displayed on one or more of the displays 124, as indicated by block 506. For example, FIG. 6A illustrates an example of a first image 130, either in the form of a video or a photograph, captured by a first sensor 92-1. As seen, the captured information can provide a variety of information, including, for example, the location of coverage areas at which crop residue has been spread onto the ground surface 134, as well as other, non-coverage areas. In the illustrated embodiments, the coverage areas are represented as one or more collections of crop residue 132a-f. Further, in this example, the collections of crop residue 132a-f on the ground surface 134 of a field are being shown on a first display 124 of the agricultural machine 10. Similarly, FIG. 8A illustrates a first image 136 in the form of a video or a photograph, captured by a second sensor 92-2, of a plurality of pieces of crop residue 138 that are being outputted from a chopper 69, and which are being displayed on the display 124. Thus, in the provided examples, the first and second sensors 92-1, 92-2 can both be optical cameras. Further, the displays 124 shown in FIGS. 6A, 7A, and 8A can be the same display 124, wherein the operator can toggle between the different first images 130, 130′, 136, or, alternatively, the displays 124 shown in FIGS. 6A, 7A, and 8A can be different displays 124.

According to certain embodiments, the first images 130, 130′, 136 shown in FIGS. 6A, 7A, and 8A are generally live or real-time images 130, 130′, 136, including, for example, live streams of images 130, 130′, 136. For example, such live or real-time display of the first images 130, 130′, 136 on the display(s) 124 can generally reflect what the sensors 92-1, 92-2 are currently capturing, aside from the time that may be associated with the processing, communicating, and generating the display of the associated signal(s) such that the first image 130, 130′, 136 appears on the display(s) 124. Additionally, according to certain embodiments, the image 130, 130′, 136 can be a real-time photograph captured by the sensor 92-1, 92-2 that pertains to the most recent image captured by the sensor 92-1, 92-2, and processed for display, or, alternatively, real-time in that displayed first image 130, 130′, 136 is the image from which the analytical unit 110 most recently obtained crop residue parameter information.

As indicated in FIG. 5, the image 130, 130′, 136 from block 502 can be processed at block 508. Such processing can include, for example, the image 130, 130′, 136, or the associated captured information, including data contained therein, being converted to a file format, or other form, that can accommodate analysis of the captured information by the analytical unit 110.

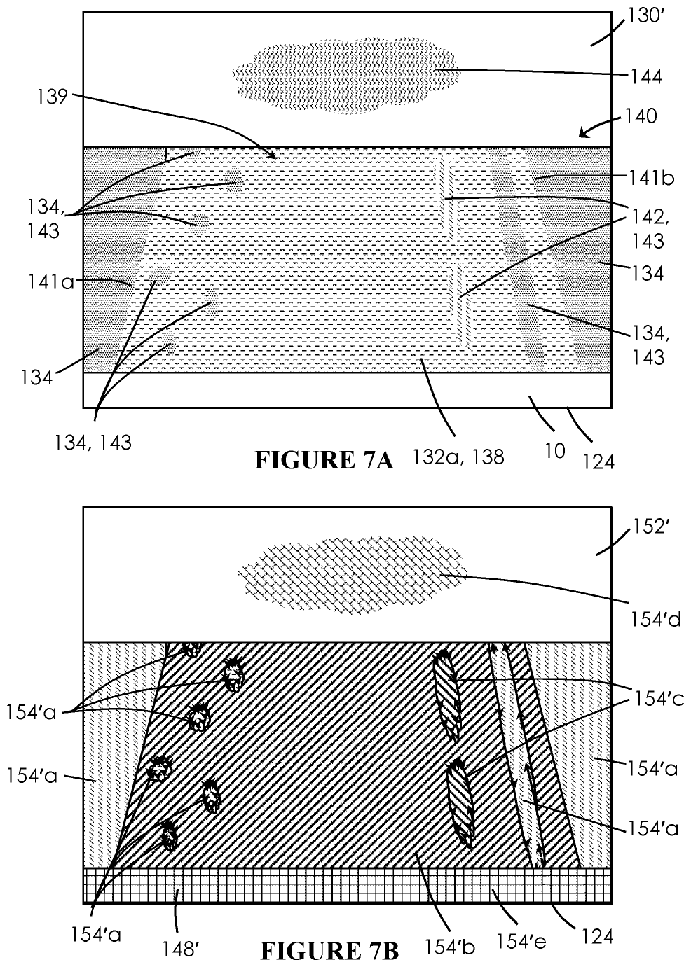

At block 510, the image data obtained or derived using the captured information can be classified. For example, the system 100 can identify the type of captured information that is, or is anticipated to be, contained within the information provided by the sensor 92-1, 92-2. Thus, the system 100 can identify the type of captured information that is anticipated to be provided by the first image 130, 130′, 136, and, moreover, the type of captured information the analytical unit 110 is to analyze from the captured information. According to certain embodiments, the system 100 can identify the type of captured information that analytical unit 110 is to analyze by identifying which sensor 92-1, 92-2 is providing the captured information. For example, according to certain embodiments, the captured information provided by the one or more first sensors 92-1 can be anticipated to contain a first category of image features, which can correspond to representations, including images, of particular objects or items. Referencing the first images 130, 130′ shown in FIGS. 6A and 7A, such a first category of image features 140 can correspond to representations of one or more of a ground surface 134 (including, for example, dirt), one or more collections of crop residue 132a-f, crop stubble 142, dust 144, and portions of the agricultural machine 10, among other objects or items that can be anticipated to be in the first image 130. Similarly, captured information provided by the one or more second sensors 92-2 can be anticipated to contain representations, including images, of a second category of image features 140, that may, or may not, include at least some of the same image features of the first category of image features. For example, referencing the first image 136 shown in FIG. 8A, the second category of image features 140 can include representations of captured information corresponding to chopped pieces of crop residue 138, the agricultural machine 10 (including for example, adjacent walls), and debris, and dust 144 (FIG. 6A), among representation of other objects or items. However, as previously discussed, unlike the first sensor(s) 92-1, the second sensor(s) 92-2 can be positioned within the internal region of the agricultural machine 10. Thus, the second category of image features 140 associated with captured information provided by the first image 136 from the second sensor 92-1 may not include image features 140 such as crop stubble 142 or ground surface 134 that may be represented in the captured information provided by the first image 130 from the first sensor 92-1. Thus, by knowing which sensor 92-1, 92-2 is providing the captured information, the system 100, including the analytical unit 110 can determine which category of image features are to be examined, and, moreover, which image features 140 to seek to identify in the captured information.

The analytical unit 110 can be configured to identify the image features 140 in a variety of different manners. For example, according to certain embodiments, the analytical unit 110 can identify image features 140 at a pixel level, including, for example, based on the color, lack of color, differences in colors, lack of differences in the color(s) in one or more pixels or regions of the first image(s) 130, 130′, 136. The analytical unit 110 can be also be configured to identify an image feature 140 based on a size, shape, or position of the image feature 140 in the first image 130, 130′, 136. Image features 140 can also be identified by the analytical unit 110 based on an indication of movement, such as based on a change in position relative to at least other image features 140, as indicated by captured information obtained by the sensor 92-1, 92-2 at different times. For example, the analytical unit 110 can be configured to identify a portion of the agricultural machine 10 in the captured information based on the size, shape, color, or position of the agricultural machine 10 in a first image 130, 130′, 136. Additionally, the analytical unit 110 can utilize captured information from a plurality of first images 130, 130′, 136 to determine that, based on changes in position relative to other image features 140, certain captured information corresponds to the agricultural machine 10. According to certain embodiments, the analytical unit 110 can also utilize information attained via the training of the neural network 121 of the AI engine 120 to identify the presence and location of image features 140, including distributed crop residue 138 in collections of crop residue 132a-f within the captured information.

At block 512, having identified the image features 140 within the captured information in the first image 130, 130′, 136, the analytical unit 110 can determine crop residue parameter information relating to at least some of the image features 140. The type of analysis performed at block 512 can, for example, be based on the type of parameter and the information provided to, or otherwise derived by the analytical unit 110, including, but not limited to, the type of information provided by the sensor(s) 92 being utilized. For example, an identified image feature 140 relating to one or more collections of crop residue 132a-f can at least assist in an evaluation at block 512 of either or both the evenness in the spreading of crop residue 138 across a ground surface 134 or an amount of crop residue presented in a collection of crop residue 132a-f. Moreover, such an identified image feature 140 can be used by the analytical unit 110 to derive information regarding a width of a collection of crop residue 132a-f, the size of a non-coverage area(s) (if any) within or around the collections of crop residue 132a-f, or the depth(s) of the collections of crop residue 132a-f, as well as combinations thereof, among other information.

FIGS. 6A and 7A provide examples of analysis of the crop residue distribution using size information of crop residue in collections of crop residue 132a-f. With respect to the below discussed example provided by FIGS. 6A and 6B, such size information can be at least partially based on a determined amount of crop residue in one or more collections of crop residue 132a-f. Moreover, in the example discussed below, such information can correspond to an estimation of a size, such as, for example, depth, between an upper surface of the collection of crop residue 132a-f and the adjacent ground surface 134. Such information can, according to certain embodiments, be derived from captured information that is provided by one or more first sensors 92-1, including, but not limited to, a depth camera or sensor, alone or in combination with another type of sensor(s), including for example, LIDAR, that can provide depths, distances, or positional information that can be used by the analytical unit 110. With respect to the examples discussed below with respect to FIGS. 7A and 7B, such size information can relate to the size of one or more coverage areas 139 or non-coverage areas 141, or both, along the ground surface 134. Alternatively, or additionally, the analytical unit 110 can be trained or programmed to utilize size information, such as, for example the size information discussed below with respect to at least FIGS. 6A-7B, and to provide an estimate as to the extent crop residue is being evenly spread onto the ground surface 134 by the agricultural machine 10. Such training or programming of the analytical unit 110 can also include training to estimate the amount of crop residue 138 in the collection of crop residue 132a-f. According to certain embodiments, the analysis by the analytical unit 110 can, for example, be at least partially based on colors or brightness of pixels or regions within the first image(s) 130, 130′, 136, as well as differences or changes in such features, in the first image(s) 130 130′, 136.

According to certain embodiments, the analytical unit 110 can also be configured to use the determined size information to assign different collections of crop residue 132a-f, or areas within each collection of crop residue 132a-f, to different size categories. According to certain embodiments, the categories can relate to depth categories, or, alternatively, sizes of coverage areas. For example, with respect to the example shown in FIGS. 6A and 6B, the categories can correspond to depth categories. Additionally, the depth categories can provide an indication of relative depths across different areas of a collection of crop residue 132a-f, or relative to other collections of crop residue 132a-f. For example, according to certain embodiments, one depth category, such as, for example, a second depth category, can correspond to a medium depth of crop residue in a collection of crop residue 132a-f. According to such an embodiment, one of the first and third depth categories can correspond to a depth that, relative to medium depth, is below the medium depth by a first predetermined amount, and the other of the first and third depth categories can correspond to a relative depth that is above the medium depth by a second predetermined threshold. The first and second predetermined thresholds may, or may not, be the same. Such variations in the relative depths within the same collection of crop residue 132a-f, or among different collections of crop residue 132a-f, may be used to at least determine if crop residue is, or is not, being evenly distributed. The depths can also be measured or quantified by the analytical unit 110 in a variety of different manners, including, for example, using a unit of measurement, among other means of quantifying the depth of the collections of crop residue. As discussed below, such categories can be assigned visually distinctive virtual representations for display so as to provide a visual indicator to an operation of the variances (if any) in the distribution or spreading of crop residue by the agricultural machine 10 onto the ground surface 134.

Alternatively, with respect to the example provided by FIGS. 7A and 7B, the categories can be based on the size of areas of the ground surface 134 that are covered by crop residue 138 (e.g. coverage areas 139), including the size of coverage areas 139 that may, or may not, be interrupted by the presence of a non-coverage area 143. Alternatively, the categories can be based on the percentage of an area in a field that corresponds to a coverage area 139, and the percentage of that same area that corresponds to a non-coverage area 143, and moreover, the portion of the area that is not covered by crop residue.

Additionally, or alternatively, according to other embodiments, the analytical unit 110 can be configured to estimate a degree of processing of crop residue, such as, for example, processing corresponding to crop residue being chopped by the chopper 60. The extent crop residue has, or has not, been processed can be derived in a number of manners. For example, according to certain embodiments, the extent crop residue has been processed by the agricultural machine 10, including by the chopper 69, can be determined by evaluating one or more physical shapes or sizes, or both, of the crop residue. Such an evaluation may be based on a physical appearance of crop residue without utilizing a specific unit of measurement, while other embodiments may include use of one or more units of measurement. Referencing the first image 136 shown on the display 124 depicted in FIG. 8A, the analytical unit 110 can be adapted to estimate a central longitudinal length between opposing ends 146a, 146b of a plurality of chopped crop residue 138 that appears in the one or more first image(s) 136. Further, according to certain embodiments, the analytical unit 110 or processor 104 can at least temporarily maintain a record of the estimated lengths of the crop residue 138 such that the analytical unit 110 can provide an indication or representation of the portion or percentage of crop residue 138 that has a length above, below, or within a particular predetermined length threshold, including, but not limited to, with a range of predetermined lengths, as discussed below. For at least purposes of illustration, a direction of an exemplary length of a chopped piece of crop residue 138 is generally indicated by “L” in FIG. 8A.

At block 514, the controller 102 can identify whether an overlay feature for displaying information relating to the determined parameters is, or is not, activated. For example, according to certain embodiments, the display 124 or other areas in the operator cab 16 can provide a user interface that can accommodate activation or deactivation of an overlay feature by the operator. If the overlay option is deactivated, then as shown in FIG. 5, the method can resume with continuing to process one or more first images 130, 130′, 136 that continue to be captured via operation of the sensors 92.

If the overlay feature is activated, then at block 516, the crop residue parameter to be displayed on the display 124 can be identified. Moreover, at block 516 the controller 102, including, but not limited to, the one or more of the processors 104, can identify, or be informed as to a selection made as to, which crop residue parameter information is to be shown on the display 124. According to certain embodiments, such an identification can relate, for example, to whether the operator is seeking information regarding the distribution or spreading of crop residue 138 by the agricultural machine 10 onto the ground surface 134, or whether the operator is seeking information regarding a physical characteristic of the crop residue 138. Additionally, the information or selection at block 516 can also provide an indication to the controller 102 as to the manner or format the crop residue parameter information is to be presented or arranged in the overlay on the display 124. For example, FIGS. 8B, 8C, and 8D illustrate optional formats for presenting crop residue parameter information as one or more second images in the forms of overlays 150a-c on the display 124, as discussed below.

At block 518, the controller 102 can be operated to generate one or more second images 152, 152′, 156 that can include overlays 148, 148′, 150a-c providing virtual representations of crop residue parameter information positioned over the one or more first images 130, 130′, 136 that is/are being displayed in connection with at least above-discussed block 506. Examples of such overlays 148, 148′, 150a-c are shown, for example, in FIGS. 6B, 7B, 8B, 8C, and 8D. According to certain embodiments, the overlays 148, 148′, 150a-c can be at least partially transparent so that at least a portion of the one or more first images 130, 130′, 136 being displayed in on the display 124 remain visible to the operator. The extent to which the overlays 148, 148′, 150a-c are, or are not, transparent can, via use of the I/O device 122, be selectively adjusted to the preferences of the operator. Additionally, the visual, or virtual, representations of the crop residue parameter information contained in the second images 152, 152′, 156 via an overlay 148, 148′, 150a-c can utilize a variety of different colors, pattern filing, graphs, terms, or numerical information, as well as combinations thereof, among other representations, to convey different crop residue parameter information to the operator.

For example, FIG. 6A illustrates the display of a first image 130 in the form of a photograph or video that has been, or is being, captured by a first sensor 92-1, and which is displayed on the display 124. Further, the displayed first image 130 is shown as having captured information that includes identified image features 140 from the first category of image features 140, as discussed above with respect to at least block 506. FIG. 6B illustrates a second image 152 being displayed on the display 124 that includes at least a portion of the first image 130 shown in FIG. 6A, as well as an overlay 148 positioned over at least a portion of the first image 130. Moreover, the overlay 148 in the illustrated second image 152 provides one or more virtual images or representations 154a-g over at least a portion of some corresponding identified image features 140 shown in the first image 130 in FIG. 6A. For example, while the display of the first image 130 shown in FIG. 6A can be a photograph or video of collections of crop residue 132a-f, among other image features 140, the second image 152 shown in FIG. 6B is displaying an overlay 148, including, for example, a virtual representations 154a-g of those collections of crop residue 132a-f. Moreover, the second image 152 includes an overlay 148 having virtual representations 154a-g that are positioned over the collections of crop residue 132a-f of the first image 130. Further, as previously mentioned, the overlay 148, and associated virtual representations 154a-g, can be at least partially transparent such that at least a portion of the first image 130 positioned beneath the overlay 148, or virtual representations 154a-g, is at least partially visible.

As also seen in by the second image 152 shown in FIG. 6B, according to certain embodiments, at least some of the identified features from the first image 130 are not overlaid by the overlay 148, or a corresponding virtual representation in the second image 152 (FIG. 6B). For example, the ground surface 134, crop stubble 142, dust 144, and agricultural machine 10 seen in the first image 130 are not overlaid by the overlay 148 or a virtual representation in the second image 152 shown in FIG. 6B. However, according to other embodiments, features related to one or more, if not all, of the ground surface 134, crop stubble 142, dust 144, and agricultural machine 10 can be represented in the overlay 148 by a virtual representation.

The virtual representations 154a-g can have a variety of configurations. For example, in FIG. 6B, the virtual representations 154a-g, or collection of virtual representations 154a-g, can have shapes, sizes, colors, patterns, or fills, as well as combinations thereof, that correspond to the collections of crop residue 132a-f that are spread onto the ground surface 134. Further, the shapes and sizes of the virtual representations 154a-g can also correspond to associated parameters. For example, with respect to parameters that relate to relative depths of collections of crop residue 132a-f spread onto the field by the agricultural machine 10, different shapes and sizes of the virtual representation(s) 154a-g within a particular area(s) of the collections of crop residue 132a-f can correspond to different relative depths, or ranges of depths, of the collections of crop residue 132a-f within those representations 154a-g. Thus, with respect to the example shown in FIG. 6B, a collection of crop residue 132c can be virtually represented by a collection of virtual representations 154a-g that includes a first virtual representation 154c corresponding to a determined depth, or range of depth, of the collection of crop residue 132c in one area of the collection of crop residue 132c, and at least one other virtual representation 154g corresponding to a different determined depth, or range of depth, including a relative depth, in one or more other areas of that same collection of crop residue 132c.

The virtual representations 154a-g can also be configured to provide information regarding the associated crop residue parameter information for the identified image features 140, as determined, for example, at block 512. For example, the virtual representations 154a-g can include one or more parameter identifiers 158a-c (FIG. 6B) which can provide a visual representation correspond to a value, or range of values, for the associated parameter. The parameter identifiers 158a-c, or differences between each of the parameter identifiers 158a-c, can be expressed in a variety of manners, including, but not limited to, via colors, patterns, or solid or broken line outline formatting, as well as combinations thereof, among other visual characteristics. Such distinguishing features for the parameter identifiers 158a-c can provide a visual indication of a value, range, or category to which a value has been determined for the associated crop residue parameter information. Additionally, or alternatively, the virtual representation 154a-g can include a display of either, or both, an associated numerical value or text associated with the determined value for the associated crop residue parameter information. For example, FIG. 6B illustrates three different parameter identifiers 158a-c in the form of different styles of pattern fills for the virtual representations 154a-g. Each of the pattern fills for the parameter identifiers 158a-c can correspond to a different value, or range of values, determined for the crop residue parameter information at that particular area or region of the collection of crop residue 132a-f. For example, according to certain embodiments, a parameter identifier 158a can correspond to an average or medium depth of crop residue in a collection of crop residue 132a-f. The determined average or medium depth can be utilized as a guideline or basis, which may be referred to herein as a target, depth. A second parameter 158b can therefore correspond to a determined parameter value that is below the target depth, including, for example, less than the target depth by a degree greater than a first predetermined threshold, and a third parameter 158c corresponding to a determined parameter value that is above the target depth by an amount that is greater than a second predetermined threshold for the crop residue parameter information.

Therefore, in the example shown in FIG. 6B, the parameter for the identified feature is the depths of the collections of crop residue 132a-f that are spread on the ground surface 134 by the agricultural machine 10. Thus, at block 512, a determination can be made, using captured information provided by the one or more first sensors 92-1, as to the depths of the collections of crop residue 132a-f, including at various locations with each collection of crop residue 132a-f. Using the different parameter identifiers 158a-c, the overlay 148 can visually provide an indication to the operator as to whether crop residue is, or is not, being evenly spread or distributed along the ground surface 134. For example, in FIG. 6B, a first parameter identifier 158b indicates that first and second collections of crop residue 132a, 132b, shown by virtual representations 154a, 154b, are below the target depth. The example in FIG. 6B also shows a third parameter identifier 158c that indicates that the fifth and sixth collections of crop residue 132c, 132f, shown by virtual representations 154e, 154f, are below the target depth threshold for crop residue depth. Similarly, a second parameter identifier 158a indicates that the fourth collection of crop residue 132d satisfies the target depth for crop residue depth. With respect to the third collection of crop residue 132c, a portion of the collection of crop residue 132c, shown by a parameter identifier 158a in virtual representation 154c, satisfies the target depth, while another portion of the collection of crop residue 132c, shown by a parameter identifier 158b in virtual representation 154g, is below the target depth.

FIG. 6B also illustrates the second image 152 having an optional legend 160. As seen, such a legend 160 can further assist the operator in understanding the information being presented by the three different parameter identifiers 158a-c. Thus, in this example, the legend 160 can include a corresponding indication, which can be either, or both, a textual indication or a numerical indication or explanation, as to the meaning or value associated with the displayed parameter identifiers 158a-c.

FIGS. 7A and 7B illustrate another example of captured information provided by a sensor 92 being utilized, such as, for example, by at least the analytical unit 110 to determine crop residue parameter information that can be presented at least in the form of an overlay 148′. For instance, FIG. 7A depicts a first image 130′ displaying, on the display 124, a collection of crop residue 132a that has been deposited on the ground surface 134 by the agricultural machine 10. As shown, in this example the identified image feature(s) 140 can correspond to the ground surface 134 that is visible in the first image 140, which may indicate detection of dirt or other debris that is not covered by crop residue 138. The identified image features 140 can also include one or more, if not all, of crop stubble 142, dust 144, a portion of the agricultural machine 10, and crop residue 138, including a plurality of crop residue 138 that forms one or more collections of the crop residue 132a. For example, according to certain embodiments identified image feature(s) 140 can be derived from the captured information using the colors or brightness of pixels or regions within the first image(s) 130′, as well as differences or changes in such features, in the first image(s) 130′.

Using the captured information, the analytical unit 110 can identify crop residue parameters for either or both the crop residue 138 or collection of the crop residue 132a, including, for example, one or more sizes of coverage areas 139 on the ground surface 134, as provided by the collection of the crop residue 132a. For example, according to certain embodiments, the crop residue parameter can correspond to a width between opposing edges 141a, 141b of the collection of crop residue 132a. The crop residue parameter can also correspond to the size, portion, or percentage of the collection of the crop residue 132a that does, or does not, have crop residue 138, or at least a certain degree of crop residue 138. Additionally, or alternatively, the crop residue parameter can correspond to coverage percentage, which can provide an indication of a percentage of an area of the ground surface 134 that has a coverage area 139 or a non-coverage area 143. For example, in the illustrated example shown in FIG. 7A, non-coverage areas 143 can be interspersed or scattered along areas within the collection of the crop residue 132a. For example, as seen in the example provided by FIG. 7A, the collection of the crop residue 132a may not be uniform in that areas of ground surface 134 or crop stubble 142 can be seen as being present between the opposing edges 141a, 141b of the collection of crop residue 132a. Such presence of non-coverage areas 143 can provide an indication that crop residue is not being evenly spread onto the ground surface 143. Further, the locations, sizes, shapes, or concentration of non-coverage areas, as well as combinations thereof, can provide an indication of the extent certain regions of the collection of the crop residue 132a are receiving less crop residue 138 than other areas of the collection of the crop residue 132a. Such a determination can also include comparisons of different areas of the collection of the crop residue 132a for the presence and extent of non-coverage areas. Using such information, the analytical unit 110 may be able to not only identify both coverage and non-coverage areas, but also provide estimates that quantify the differences in the amounts of crop residue 138 present at different areas within the collection of crop residue 132a. Such an estimate can then be utilized to determine adjustments to operational settings so as to improve the evenness of the distribution, or spreading, of crop residue 138 onto the ground surface 134.

FIG. 7B illustrates an exemplary second image 152′ having an overlay 148′ providing sensed crop residue parameter information that is positioned over at least a portion of the image 130′ that is being displayed in FIG. 7A. In the example shown in FIG. 7B, the crop residue parameter corresponds to the uniformity the crop material is spread onto the ground surface 134, which can also be referred to as distribution uniformity. As mentioned above, such a parameter can be evaluated, or estimated based on one or more sizes of coverage areas 139 and non-coverage areas 143. Further, as indicated above, such crop residue parameter information can be estimated based on the sizes, locations, and concentration of non-coverage areas 143, if any, in one or more collections of crop residue 132a.

Thus, with respect to the example, shown in FIGS. 7A and 7B, at block 512, using the different virtual representations 154′a-e, the overlay 148′ can visually provide an indication to the operator as to the presence and location of ground surface 134 that is visible in the first image 140′, crop residue 138 (or collection of crop residue 132a), crop stubble 142, dust 144, or the agricultural machine 10 in the second image 152′. For example, as seen in FIG. 7A, a first virtual representation 154′a can indicate the presence and location of ground surface 134 that is seen in the first image 140′ that is not covered by crop residue 138. Additionally, a second virtual representation 154′b can correspond to crop residue 138 or a collection of crop residue 132a, a third virtual representation 154′c can correspond to crop stubble 142, a fourth virtual representation 154′d can correspond to dust 144, and a fifth virtual representation 154′e can correspond to a portion of the agricultural machine 10.

As previously mentioned, such virtual representations 154′a-e can be visually presented in the overlay 148′ in a variety of manners, including, for example, via use of particular patterns, shapes, outlines, fills, or colors, as well as combinations, that can allow each virtual representation 154′a-e to be visually distinctive, or identifiable, relative to the other virtual representations 154′a-c. Additionally, while FIG. 7B illustrates a plurality of virtual representations 154′a-e being used for a plurality of different features seen in the first image 140′, the number of features shown in the overlay 148′ in the form of a virtual representation 154′a-e can vary. For example, according to certain embodiments, the operator may select which virtual representations 154′a-e are to appear in the overlay 148′. While not shown, the overlay 148′ may, or may not, also include a legend 160.

With respect to FIG. 8A, similar to FIG. 6A, FIG. 8A illustrates a first image 136 that can, for example, be one or more photographs or videos that is/are displayed on the display 124. In the illustrated embodiment, the first image 136 shown in FIG. 8A is obtained from the operation of one or more of the second sensors 92-2. Thus, as discussed above, in this example, the captured information can include an image feature 140 corresponding to a plurality of pieces of crop residue 138 located downstream of the chopper 69. Thus, as previously discussed, the crop residue parameter evaluated by the analytical unit 110 using the captured information can correspond to an extent the crop residue 138 has been processed, which may be indicated, for example, by either a representation or measured length, or chopped length (L), of the crop residue 138, among other characteristics of the crop residue.

FIGS. 8B, 8C, and 8D illustrate second images 156 being displayed on the display 124 that include the first image 136 shown in FIG. 8A, and an overlay 150a-c. As with the overlay 148 shown in FIG. 6B, the overlays 150a-c shown in FIGS. 8B, 8C, and 8D each include one or more parameter identifiers 162a-c. The parameter identifiers 162a-c in FIGS. 8B, 8C, and 8D can be a combination of geometric shapes, colors, and text. For example, FIG. 8B illustrates an overlay 150a in which each of the parameter identifiers 162a-c are a combination of a geometric shape 164a-c in the form of a graphical bar, and an associated text descriptor 166. The geometric shape 164a-c can have a size, such as, for example, a length, that can correspond to associated determined crop residue parameter information for a collection of chopped pieces of crop residue 138. In addition to, or in lieu of, information being presented via sizes of the geometric shapes 164a-c, similar information can be visually conveyed via use of different colors, or shades of colors. In the illustrated example, the size of the geometric shape 164a-c can each correspond to the portions of a collection of crop residue 138, or percentages of crop residue, for which the determined crop residue parameter information is within one of the three categories or ratings of parameter identifiers 162a-c. Thus, in the illustrated examples, as indicated by each of the text descriptors 166, the geometric shape 164a for the first parameter identifier 162a can correspond to a percentage or portion of crop residue 138 having a length that is determined to be within the predetermined threshold. The determination of such a crop residue parameter can also be determined, and visually represented with respect to the extent the crop residue 138 is being processed, as indicated by the text descriptors 166 “OVER”, “IDEAL”, and “UNDER” in FIGS. 8B-D. The geometric shape 164b for the second parameter identifier 162b can correspond to the percentage or portion of crop residue 138 having a length that is determined to be above or over the predetermined or target threshold value. The geometric shape 164c for the third parameter identifier 162c can therefore correspond to a percentage or portion of crop residue 138 having a length that is determined to be below or under the predetermined or target threshold value.

As mentioned above, according to the examples shown in FIGS. 8B-8D, the captured information can be utilized by the analytical unit 110 to determine whether crop residue 138 has been processed to satisfy particular parameter thresholds. According to certain embodiments, the parameter thresholds can related to a size, such as, for example, a length, of the pieces of crop residue 138. However, a variety of other types of parameters thresholds relating to the processing of crop residue 138 by the agricultural machine 10 can be utilized. If a determination is made, such as, for example, by the analytical unit 110, that a piece of crop residue 138 is within the predetermined threshold, the analytical unit 110 can categorize or rate that piece of crop residue 138 accordingly, In the illustrated embodiments, pieces of crop residue 138 determined to satisfy the predetermined threshold can be categorized in, or rated as belonging to, a first category. For example, as seen in FIGS. 8B-D, in the illustrated embodiment, the first category can be referred to, via a text descriptor 166, as “IDEAL”, among other category identifiers. If however a piece of crop residue 138 is determined to not be within the predetermined threshold, the analytical unit 110 can categorize or rate that piece of crop residue 138 in a different, or other category or rating. For example, in the embodiments relating to FIGS. 8B-D, in addition to the first category or rating (“IDEAL”), second and third categories or ratings are utilized. In such examples, the second category or rating (identified in FIGS. 8B-D by the text descriptor 166 “OVER”) can correspond to crop residue 138 having a size or characteristic, such as, for example length, that is larger than the predetermined threshold. Conversely, the third category or rating (identified in FIGS. 8B-D by the text descriptor 166 “UNDER”) can correspond to crop residue 138 having a size or characteristic, such as, for example length, that is smaller than the predetermined threshold. According to certain embodiments, for two or more, if not all, of the categories or ratings (e.g., “IDEAL”, “OVER”, “UNDER”), and for at least a predetermined or selected time interval, the analytical unit 110, or other component of the controller 102, can record or track the number of pieces of crop residue 138 identified as belonging to that category or rating. Such information can, for example, provide an indication of the amount, including, but not limited to, percentage of crop residue that is, or is not, being processed in a manner that satisfies the predetermined threshold. Such an indication of the amount of crop residue that is, or is not, being processed to satisfy the predetermined threshold can be displayed in an overlay 150a-c, such as, for example, via use of graphs, charts, numerical values, or colors, as well as combinations thereof, among other manners of display. Further, for example, different colors can be used to represent the different categories or ratings. Additionally, or alternatively, different category colors can be overlaid in a virtual representations of crop residue 138 in the overlay 150a-c in a manner that may provide a visual indication to the operator of the concentration of crop residue 138 seen in the second image 156 that falls within one of the different identified categories or ratings.

While the foregoing example is discussed utilizing analysis of individual pieces of crop residue 138, a similar approach can also be utilized using a collection of crop residue 138. For example, according to certain embodiments, the analytical unit 138, among other components of the controller 102, can analyze a collection of crop residue together, or as a whole, using captured information from the first image 136, including from a still image or photograph from the first image 136. According to certain embodiments, the analytical unit 110 can utilize information, instructions, or one or more models that were obtained via machine learning in categorizing or ranking a collection of crop residue. Further, according to certain embodiments, such machine learning, or development of the associated information or model(s), can be achieved by the AI engine 120 and associated neural network 121.

In the embodiment shown in FIG. 8B, the parameter identifiers 162a-c, including both the geometric shapes 164a-c and the associated text descriptor 166, shown in the second image 156 are positioned over at a portion of the first image 136. Further, according to certain embodiments, the parameter identifiers 162a-c can be at least partially transparent such that at least a portion of the first image 136 can be seen through the overlay 150a. FIGS. 8C and 8D however illustrate alternative embodiments in which the second image 156 comprises a smaller, reduced, or shrunken version of the first image 136 such that the second image 156 displayed by the display 124 shows the overlay 150b, 150c in a manner that does not cover the first image 136. Further, with respect to the overlay 150c shown in FIG. 8D, the text descriptor 166 can be incorporated into the geometric shape, including being overlaid within the geometric shape 164a-c. In such an example, break lines 168 can be used to provide an indication of the different sizes or areas in the illustrated line bar graph, and, moreover, the percentages or relative amounts of crop residue 138 that belongs to each of the displayed categories or ratings, as indicated by the associated text descriptor 166.

While FIGS. 8B-8D show particular embodiments and arrangements of overlays 150a-c, the illustrated overlays 150a-c can be incorporated into any of the embodiments shown in FIGS. 8B-8D, as well as the overlay 148 shown in FIG. 6B. Further, while the overlays 150a-c are shown as having particular geometric shapes 164a-c and the associated text descriptor 166, a variety of different types, shapes, sizes, colors, arrangements of geometric shapes 164a-c, or associated text descriptors 166, as well as various combinations thereof, can be utilized. Additionally, arrangements other than bar graphs can be utilized to indicate differences in the relative amounts or portions of image features 140 for which the associated crop residue parameter information is determined to not satisfy the predetermined or target threshold value. Additionally, while each of FIGS. 6B and 8B-D illustrate three different parameter identifiers 158a-c, 160a-c, according to certain embodiments, more or fewer parameter identifiers 158a-c, 160a-c can be utilized. Further, while FIG. 8B illustrates both the geometric shapes 164a-c and associated text descriptors 166 overlaying the first image 136, and FIGS. 8C and 8D illustrate neither the geometric shapes 164a-c nor the text descriptors 166 overlaying the first image 136, according to other embodiments, one of the geometric shapes 164a-c and the text descriptors 166 can overlay the first image 136 while the other of the geometric shapes 164a-c and the text descriptors 166 does not overlay the first image 136.

Referring again to FIG. 5, according to certain embodiments, a determination that the crop residue parameter information does not satisfy a predetermined or target threshold, can, indicated by at least block 520 and block 524, trigger the system 100 to identify at least potential adjustments in certain operational settings of the agricultural machine 10. For example, with respect to crop residue parameters relating to the depth of collections of crop residue 132a-f, the controller 102, analytical unit 110, or processor 104 can identify the spreader actuator 128 or the propulsion system 129, and associated settings, that can be adjusted. Such adjustments can relate to the speed at which the propulsion system 129 is controlling the speed at which the agricultural machine 10 is being propelling forward via at least a use of a power or force provided by an engine of the agricultural machine 10. Additionally, or alternatively, such adjustments can relate to a speed at which the spreader 82, or an associated spreader vane, is being operated to disburse crop residue 138 onto the ground surface 134. Further, with respect to the length of chopped crop residue 138, the chopper actuator 126 can be identified as the component that may be adjusted to cause change in the crop residue 138 length. Further, the speed at which the chopper actuator 126 is facilitating rotational displacement of the chopper rotor 74, and thus corresponding displacement of the chopper knives 76, can be identified as the setting that is to be adjusted. Additionally a position of the knives 78 that oppose the chopper knives of the chopper 69 can be identified as the setting that is to be adjusted. The identified differences or discrepancies between the determined crop residue parameter information and the associated predetermined or target threshold can also be used to at least identify adjustments in one or more of the settings or operations of the identified components.

According to certain embodiments, the recommended adjustment(s) from block 524 can be presented to the operator, such as, for example, by the controller 102 facilitating either or both a textual or graphical representation of the recommendation(s) being shown on the display 124. The operator can then, at block 526, decide to accept, or not accept, the recommended adjustment(s), as indicated by block 524. For example, the operator can utilize the I/O device 122 or other user interface to provide an indication of an election to accept one or more of the recommended adjustments. If the operator does provide an indication of acceptance of a recommended adjustment, then at block 528 the accepted recommended adjustment can be implemented so that the associated operational setting is changed. Otherwise, if the operator elects not to accept the recommended adjustment, the method 500 can return to block 508, where subsequently determined crop residue parameter information from block 512 can again be evaluated with respect to the corresponding predetermined or target threshold at block 520. Alternatively, according to other embodiments, the adjustment(s) determined at block 524 can be automatically implemented by the controller 102, and without the approval of the operator.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

1. A method comprising:
displaying one or more first images of at least a crop residue on a display;
identifying captured information in at least a portion of the one or more first images;
identifying one or more representations of the crop residue in the captured information;
determining crop residue parameter information using at least one of the identified one or more representations of the crop residue; and
displaying a virtual representation of the determined crop residue parameter information with the display of the one or more first images.

2. The method of claim 1, wherein displaying the virtual representation comprises overlaying the virtual representation over at least a portion of the one or more first images.

3. The method of claim 2, wherein the virtual representation is at least partially transparent.

4. The method of claim 2, wherein overlaying the virtual representation comprises overlaying the virtual representation over only a portion of the one or more first images.

5. The method of claim 1, wherein determining the crop residue parameter information comprises determining a size of one or more collections of the crop residue that has been discharged from an agricultural machine.

6. The method of claim 5, wherein the size is an amount of the crop residue in the one or more collections of the crop residue.

7. The method of claim 6, wherein the virtual representation has a shape that corresponds to the shape of at least a portion of the one or more collections of the crop residue.

8. The method of claim 6, further including selecting for the virtual representation, and based on the determined size, a parameter identifier from a plurality of parameter identifiers, each parameter identifier of the plurality of parameter identifiers being both visually distinctive from the other parameter identifiers of the plurality of parameter identifiers and corresponding to a different value or range of values for the determined size.

9. The method of claim 1, wherein determining the crop residue parameter information comprises identifying the crop residue as belonging to one of a plurality of categories, each category of the plurality of categories corresponding to a different extent of processing of the crop residue.

10. The method of claim 9, wherein determining the crop residue parameter information comprises determining the crop residue parameter information for a plurality of crop residue that comprises determining at least one of the following: (a) a first indication of a first portion of the plurality of crop residue that satisfies a predetermined threshold for a length of the crop residue, and (b) a second indication of at least a second portion of the plurality of crop residue that does not satisfy the predetermined threshold for the length of the crop residue, and wherein the virtual representation comprises a representation of at least one of the first indication and the second indication.

11. The method of claim 10, wherein the second indication identifies a first group of the second portion of the crop residue that is below the predetermined threshold for the length of the crop residue and a second group of the second portion of the crop residue that is above the predetermined threshold for the length.

12. The method of claim 1, further comprising capturing the one or more first images by one or more first sensors.

13. The method of claim 1, wherein the one or more first images are displayed on the display at least in near real-time.

14. The method of claim 1, wherein identifying captured information comprises:
identifying a sensor providing the captured information; and
identifying, based on the identification of the sensor, a category of image features to be identified in the captured information.

15. A system for displaying a virtual representation of a crop residue parameter information for a crop residue, the system comprising:
at least one display;
at least one processor; and
a memory coupled with the at least one processor, the memory including instructions that when executed by the at least one processor cause the at least one processor to:
display one or more first images of at least the crop residue on the display;
identify a captured information in at least a portion of the one or more first images;
identify one or more representations of the crop residue in the captured information;
determine the crop residue parameter information from at least one of the one or more representations of the crop residue; and
display the virtual representation of the determined crop residue parameter information with the display of the one or more first images.

16. The system of claim 15, wherein the at least one processor is further configured to overlay the virtual representation over at least a portion of the one or more first images.

17. The system of claim 16, wherein the crop residue parameter information is an amount of the crop residue that is discharged from an agricultural machine.

18. The system of claim 17, wherein the at least one processor is further configured to identify the crop residue as belonging to one of a plurality of categories, each category of the plurality of categories corresponding to a different extent of processing of the crop residue.

19. The system of claim 15, wherein the at least one processor is further configured to determine an extent a plurality of the crop residue has been processed by an operation of the agricultural machine.

20. The system of claim 15, wherein the at least one processor is further configured to determine the extent a plurality of the crop residue has been processed based, at least in part, on at least one of the following: (a) a first indication that a first portion of the plurality of the crop residue satisfies a predetermined threshold for a characteristic of the crop residue, and (b) a second indication that at least a second portion of the plurality of the crop residue does not satisfy the predetermined threshold for the characteristic of the crop residue, and
wherein the virtual representation comprises a representation of at least one of the first indication and the second indication.
